(19) United States
(12) Patent Application Publication
(10) Pub. No.: US 2007/0127082 A1
(43) Pub. Date: Jun. 7, 2007

(54) Apparatus and method for processing call of Internet facsimile

(75) Inventor: Sung-hoon Bae, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/580,071

(22) Filed: Oct. 13, 2006

(30) Foreign Application Priority Data
Nov. 22, 2005 (KR) 2005-0112001

(51) Int. Cl. H04N 1/00

(52) U.S. Cl. 358/400

(57) ABSTRACT

An apparatus and method for processing calls of an Internet facsimile are provided, in which a call setting unit supports a plurality of call setting methods and performs a call setting, a controller selects a call setting method among the plurality of call setting methods and controls the call setting, and a connection unit attempts a connection to a receiving party according to the call setting method, wherein the controller selects a different call setting method, if the connection to the receiving party according to the call setting method fails. Therefore, compatibility of an Internet facsimile can be improved to allow easy communication between Internet facsimiles, which provides convenience to users.

### CROSS-REFERENCE TO RELATED PATENT APPLICATIONS

This application claims the benefit under 35 U.S.C. § 119(a) of Korean Patent Application No. 10-2005-0112001, filed on Nov. 22, 2005, in the Korean Intellectual Property Office, the entire disclosure of which is hereby incorporated by reference.

### BACKGROUND OF THE INVENTION

1. Field of the Invention

The present invention relates to an Internet facsimile. More particularly, the present invention relates to an apparatus and method for processing calls of an Internet facsimile, which automatically decide a call setting method by supporting a plurality of call setting methods to establish a connection to a receiving party, and automatically process a call request method by supporting a plurality of call request methods to establish a connection to a transmitting party.

2. Description of the Related Art

FIG. 1 is a block diagram of a conventional Fax Over Internet Protocol (FOIP)-based Internet facsimile.

Referring to FIG. 1, a scanner 100 scans documents and generates image data. A printer 110 prints facsimile documents. A host device connecting unit 120 connects the Internet facsimile to a host device such as a personal computer (PC) to receive/transmit data from/to the host device and provide functions, such as printing, scanning, and the like. A central processing unit (CPU) 130 controls all modules, and a storage unit 140 stores programs and data. A pixel converter 150 converts a document scanned by the scanner 100 into data corresponding to a facsimile protocol. A voice converter 160 converts voice signals received through a microphone into digital signals or converts digital signals into analog signals, thus performing packetizing or depacketizing, in order to transmit voice through the Internet. An Internet facsimile unit 170 converts an existing facsimile protocol into an Internet-transmittable protocol. A network interface 180 transmits facsimile data through the Internet. A controller 190 controls the entire step of the Internet facsimile unit 170.

Voice Over Internet Protocol (VOIP), which is also called Internet Protocol (IP) phone or IP Telephony, is a multimedia technique which incorporates data/voice/video using public network Intranet/Internet provided by a company or an Internet Service Provider (ISP), not using a Time Division Multiplexing (TDM) method of an existing voice telephone network. The VOIP is proposed to lower communication cost for long-distance calls or international calls, using a tremendous amount of data infrastructure ensured through the Internet.

The FOIP is proposed to transmit facsimile data through the Internet. VOIP-based call setting protocols include a H.323 protocol, a Session Initial Protocol (SIP), Media Gateway Control Protocol (MGCP), and the like. These protocols perform functions, such as call setup, call control, etc.

The FOIP generally uses the H.323 or SIP protocol as a VOIP-based call setting protocol, and uses a T.38 protocol which is a standard International Telecommunication Union-Telecommunication Standardization Sector (ITU-T) specification in order to transmit facsimile data through IP.

The H.323 protocol is proposed to allow multimedia communication in a Local Area Network (LAN) in which service quality is not ensured. The H.323 protocol, which is an Umbrella protocol, defines a system, components, technology, and call model, and includes an H.225.0 protocol and an H.245 protocol. The H.225.0 protocol has a call signaling function and the H.245 protocol has a media capability exchange function.

The SIP protocol is proposed to allow multimedia communication. The SIP protocol controls general telephone service calls to connect calls through an IP network.

The SIP protocol is an application layer control protocol of an Open System Interconnection (OSI)-based reference model which can set, change, and terminate multimedia session layers or calls.

Existing FIOP-based Internet facsimiles (ITU-T T.38) generally use the H.323 standard. In the early 2000s, H.323-based infrastructures have been mainly developed. However, recently, use of the SIP having high implementation easiness and high application utilization with respect to the H.323 standard is increasing. Accordingly, both H.323-based infrastructures and SIP-based infrastructures are currently used. However, there is difficulty in communication between Internet facsimiles in which different call setting methods are used. Also, if Internet Service Providers (ISPs) use different call setting methods, they cannot communicate with each other.

Accordingly, there is a need for an improved apparatus and method for providing communication between Internet facsimiles with different call setting methods.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an apparatus and method for processing calls of an Internet facsimile, which automatically decide a call setting method by supporting a plurality of call setting methods to establish a connection to a receiving party, and automatically process a call request method by supporting a plurality of call request methods to establish a connection to a transmitting party.

According to an aspect of exemplary embodiments of the present invention, there is provided an apparatus for processing calls of an Internet facsimile, in which a call setting unit supports a plurality of call setting methods and performs call setting; a controller selects a call setting method among the plurality of call setting methods and controls the call setting; and a connection unit attempts a connection to a receiving party according to the selected call setting method, wherein the controller selects a different call setting method, if the connection to the receiving party fails.

In an exemplary implementation, the controller sequentially selects call setting methods in a predetermined order from the plurality of call setting methods.

In another exemplary implementation, the apparatus further includes a call setting method for storing unit storing a call setting method of the receiving party, and a call setting method writing unit for writing a call setting method of the receiving party to the call setting method storing unit, if the connection to the receiving party according to the selected call setting method succeeds.

In still another exemplary implementation, the apparatus further includes a call setting method searching unit for searching the call setting method of a receiving party to be connected from the call setting method storing unit, wherein the controller selects the searched call setting method.

In a further exemplary implementation, the apparatus further includes an error display unit for displaying a message indicating that the connection to the receiving party according to the selected call setting method fails, if the connection to the receiving party according to the selected call setting method fails.

According to another aspect of exemplary embodiments of the present invention, there is provided an apparatus for processing calls of an Internet facsimile, in which a port sensing unit senses a type of port from which a connection is requested, a call request processing unit supports and processes a plurality of call request methods, and a call request processing controller controls the call request processing unit to process a call request according to a call request method corresponding to the port type.

In an exemplary implementation, the apparatus further includes a call request method storing unit for storing a call request method of a transmitting party, and a call request method writing unit for writing a call request method of a transmitting party to the call request method storing unit.

In an exemplary implementation, the apparatus further includes a processing result display unit for displaying the processed result.

According to another aspect of exemplary embodiments of the present invention, there is provided a method for processing calls of an Internet facsimile, the Internet facsimile supporting a plurality of call setting methods, in which a predetermined call setting method is selected among the plurality of call setting methods; a connection to a receiving party is attempted according to the call setting method; if the connection to the receiving party according to the call setting method fails, a different call setting method is selected except for an initial call setting method and a connection to the receiving party is attempted according to the different call setting method.

In an exemplary implementation, in the selecting of the predetermined call setting method, the predetermined call setting method is selected according to a predetermined order.

In an exemplary implementation, the method further includes if the connection to the receiving party according to the call setting method succeeds, storing a call setting method of the receiving party.

In an exemplary implementation, the method further includes searching the call setting method of the receiving party to be connected from the plurality of call setting methods; and if the call setting method of the receiving party is searched, selecting the searched call setting method.

In an exemplary implementation, the method further includes if the connection to the receiving party according to the call setting method fails, displaying a message indicating that the connection to the receiving party according to the call setting method fails.

According to another aspect of exemplary embodiments of the present invention, there is provided a method for processing calls of an Internet facsimile, the Internet facsimile supporting and processing a plurality of call request methods, in which a type of port is sensed from which a connection is requested; and a call request according to a call request method is processed corresponding to the port type.

In an exemplary implementation, the method further includes storing the call request method.

In an exemplary implementation, the method further includes displaying the processed result to a user.

According to another aspect of exemplary embodiments of the present invention, there is provided a computer-readable recording medium having embodied thereon a computer program for executing a method of for processing calls of an Internet facsimile, the Internet facsimile supporting a plurality of call setting methods.

### BRIEF DESCRIPTION OF THE DRAWINGS

The above and other objects, features, and advantages of certain exemplary embodiments of the present invention will be more apparent from the following description taken in conjunction with the accompanying drawings in which:

FIG. 1 is a block diagram of a conventional Fax Over Internet Protocol (FOIP)-based Internet facsimile;

FIG. 2 is a block diagram of an apparatus for processing calls of an Internet facsimile, according to an exemplary embodiment of the present invention;

FIG. 3 is a block diagram of an apparatus for processing calls of an Internet facsimile, according to an exemplary embodiment of the present invention;

FIG. 4 is a flowchart illustrating a method for processing calls of an Internet facsimile, according to an exemplary embodiment of the present invention; and

FIG. 5 is a flowchart illustrating a method for processing calls of an Internet facsimile, according to an exemplary embodiment of the present invention.

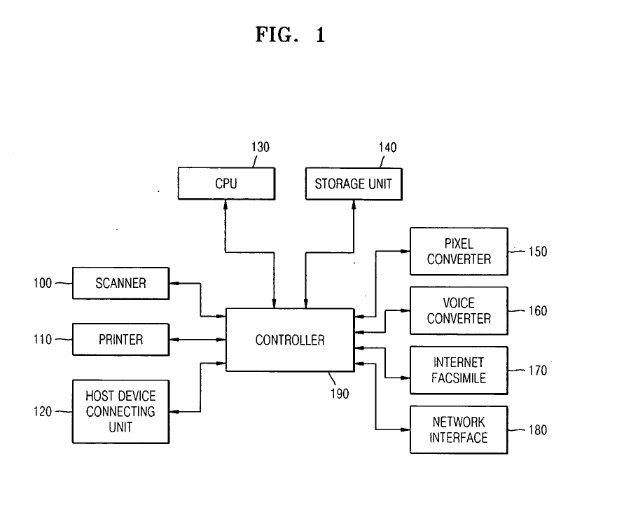

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

FIG. 2 is a block diagram of an apparatus for processing calls of an Internet facsimile, according to an exemplary embodiment of the present invention. Referring to FIG. 2, the call processing apparatus includes a call setting unit 200, a call setting method storing unit 210, a call setting method searching unit 220, a controller 230, a connection unit 240, a call setting method writing unit 250, and an error display unit 260.

The call setting unit 200 supports a plurality of call setting methods, such as an H.323 protocol, a Session Initial Protocol (SIP), and the like, and converts an existing facsimile protocol into an Internet facsimile protocol

The call setting method storing unit 210 stores call setting methods of receiving parties.

The call setting method searching unit 220 searches for a call setting method of a receiving party to be connected, from the call setting method storing unit 210.

The controller 230 selects the call setting method searched by the call setting method searching unit 220, and performs call setting according to the call setting method.

Also, if a connection to the receiving party according to the call setting method fails in the connection unit 240, the controller 230 selects a different call setting method.

The controller 230 may sequentially select call setting methods in an order set by a user.

The connection unit 240 tries a connection to the receiving party according to the call setting method selected by the controller 230.

If the connection to the receiving party according to the call setting method selected by the controller 230 succeeds, the call setting method writing unit 250 writes the call setting method of the receiving party to the call setting method storing unit 210.

If the connection to the receiving party according to the call setting method selected by the controller 230 fails, the error display unit 260 displays a processing result indicating that the connection to the receiving party according to the corresponding call setting method fails, through a display panel provided in the Internet facsimile or through a dialog box, provided in Windows, which is an operating system of a host device.

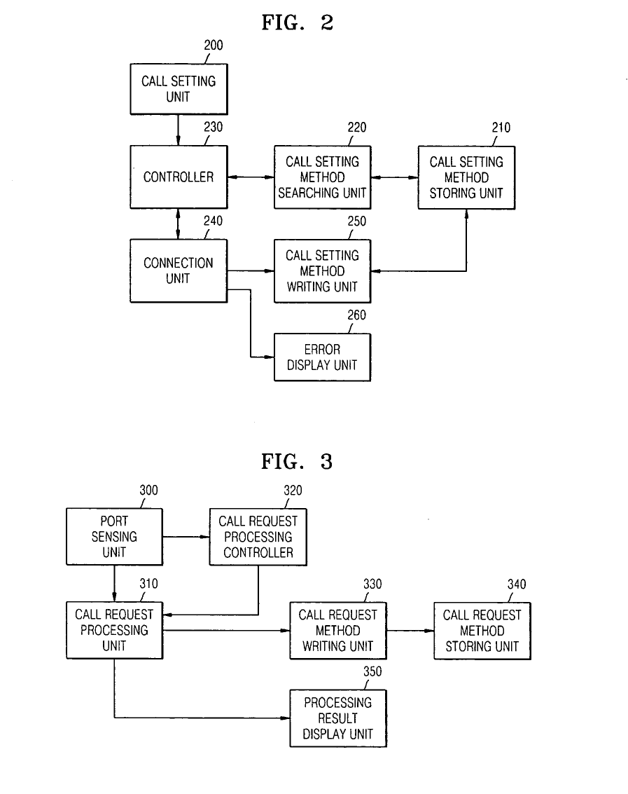

FIG. 3 is a block diagram of an apparatus for processing calls of an Internet facsimile, according to an exemplary embodiment of the present invention. Referring to FIG. 3, the call processing apparatus includes a port sensing unit 300, a call request processing unit 310, a call request processing controller 320, a call request method writing unit 330, a call request method storing unit 340, and a processing result display unit 350.

The port sensing unit 300 senses the type of port from which a connection is requested, wherein the port is a transmitting party, such as a H.323 port, a SIP port, and the like.

The call request processing unit 310 supports and processes a plurality of call request methods.

The call request processing controller 320 controls the call request processing unit 310 to convert an existing protocol into a call setting protocol corresponding to the port type sensed by the port sensing unit 300 and process a call request according to a call request method corresponding to the port type.

The call request method writing unit 330 writes the call request method of the transmitting party to the call request method storing unit 340.

The call request method storing unit 340 stores the call request method of the transmitting party.

The processing result display unit 350 displays the processing result of the call request processing unit 310, through a display panel included in the Internet facsimile or through a dialog box, provided in Windows, which is an operating system of a host device.

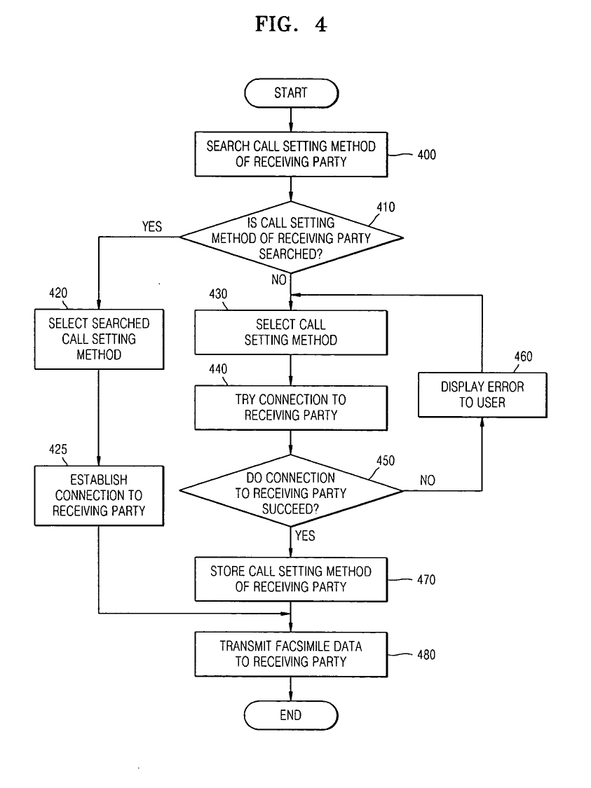

FIG. 4 is a flowchart illustrating a method for processing calls of an Internet facsimile, according to an exemplary embodiment of the present invention, wherein the Internet facsimile supports a plurality of call setting methods, such as a H.323 protocol, a SIP, and the like.

First, a call setting method of a receiving party to be connected is searched from a storing medium (step 400).

Then, a determination is made as to whether the call setting method of the receiving party is searched in step 400 (step 410).

If the call setting method of the receiving party is not searched in step 410, a predetermined call setting method is selected among the plurality of supported call setting methods (step 430). For example, call setting methods are sequentially selected according to an order set by a user.

Then, a connection to the receiving party is tried according to the call setting method selected in step 430 (step 440).

Successively, a determination is made as to whether the connection to the receiving party succeeds (step 450).

If the connection to the receiving party succeeds in step 450, the call setting method of the receiving party is stored in the storing medium (step 470).

If the connection to the receiving party fails in step 450, a message indicating that the connection to the receiving party according to the call setting method selected in step 430 fails is displayed through a display panel included in the Internet facsimile or through a dialog box, provided in Windows, which is an operating system of a host device (step 460).

After step 460, a different call setting method except for the call setting method selected in step 430, is selected (step 430).

Meanwhile, if the call setting method of the receiving party is searched in step 410, the searched call setting method is selected (step 420).

Then, a connection to the receiving party is established according to the call setting method (step 425).

After step 425 or 470, facsimile data is transmitted to the receiving party (step 480).

For example, in an Internet facsimile which supports an H.323 protocol and a SIP as call setting methods, if a call setting method of a receiving party is not searched in step 400, the H.323 protocol can be selected according to an order set by a user, in step 430. Then, a connection to the receiving party is tried according to the H.323 protocol, in step 440. If the connection to the receiving party according to the H.323 protocol fails in step 440, a message indicating that the connection to the receiving party according to the H.323 protocol fails is displayed through a display panel included in the Internet facsimile, in step 450. After step 450, the SIP is selected in step 430. Then, a connection to the receiving party is again tried according to the SIP, in step 440. If the connection to the receiving party according to the SIP succeeds in step 440, a processing result indicating that a call setting method of the receiving party is the SIP is stored in a storing medium, in step 470. After step 470, facsimile data is transmitted to the receiving party, in step 480.

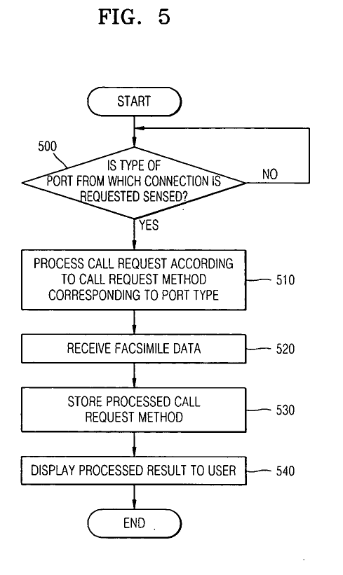

FIG. 5 is a flowchart illustrating a method for processing calls of an Internet facsimile, according to an exemplary embodiment of the present invention, wherein the Internet facsimile can support and process a plurality of port types, such as an H.323 port, a SIP port, and the like, and the corresponding call request methods.

First, the type of port from which a connection is requested among the plurality of supported port types is sensed (step 500).

If the type of port from which the connection is requested is sensed in step 500, conversion into a call setting protocol corresponding to the port type is performed and a call request is processed according to a call request method corresponding to the port type (step 510).

After step 510, facsimile data is transmitted from a transmitting party which requests the connection (step 520).

After step 520, the call request method is stored in a storing medium (step 530).

After step 530, the processed result is displayed through a display panel included in the Internet facsimile or through a dialog box, etc. provided in Windows which is an operating system of a host device (step 540).

Meanwhile, exemplary embodiments of the present invention as described above can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves.

As described above, an apparatus and method for processing calls of an Internet facsimile, according to exemplary embodiment of the present invention, automatically determines a call setting method by supporting a plurality of call setting methods to establish a connection to a receiving party, and automatically process a call request method by supporting a plurality of call request methods to establish a connection to a transmitting party.

Therefore, compatibility of an Internet facsimile can be enhanced to allow easy communication between Internet facsimiles, which provides convenience to users.

While the present invention has been particularly shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. An apparatus for processing calls of an Internet facsimile, comprising:
a call setting unit for supporting a plurality of call setting methods and performing a call setting;
a controller for selecting at least one call setting method from the plurality of the call setting methods and controlling the call setting; and
a connection unit for attempting a connection to a receiving party according to the selected call setting method,
wherein the controller selects a different call setting method, if the connection to the receiving party fails.

2. The apparatus of claim 1, wherein the controller sequentially selects the at least one call setting method from the plurality of call setting methods.

3. The apparatus of claim 1, further comprising:
a call setting method storing unit for storing a call setting method of the receiving party; and
a call setting method writing unit for writing a call setting method of the receiving party to the call setting method storing unit, if the connection to the receiving party according to the selected call setting method succeeds.

4. The apparatus of claim 3, further comprising:
a call setting method searching unit for searching for the call setting method of a receiving party to be connected in the call setting method storing unit,
wherein the controller selects the searched call setting method.

5. The apparatus of claim 1, further comprising an error display unit for displaying a message indicating that the connection to the receiving party according to the selected call setting method fails, if the connection to the receiving party according to the selected call setting method fails.

6. An apparatus for processing calls of an Internet facsimile, the apparatus comprising:
a port sensing unit for sensing a type of port from which a connection is requested;
a call request processing unit for supporting and processing a plurality of call request methods; and
a call request processing controller for controlling the call request processing unit to process a call request according to a call request method corresponding to the port type.

7. The apparatus of claim 6, further comprising:
a call request method storing unit for storing a call request method of a transmitting party; and
a call request method writing unit for writing a call request method of a transmitting party to the call request method storing unit.

8. The apparatus of claim 6, further comprising a processing result display unit for displaying the processed result.

9. A method for processing calls of an Internet facsimile, the Internet facsimile supporting a plurality of call setting methods, the method comprising:
selecting a first call setting method from a plurality of call setting methods;
attempting a connection to a receiving party according to the first call setting method; and
if the connection to the receiving party according to the first call setting method fails, selecting a second call setting method different from the first call setting method and attempting a connection to the receiving party according to the second call setting method.

10. The method of claim 9, wherein the selecting of the first call setting method comprises sequentially selecting from the plurality of the call setting methods.

11. The method of claim 9, further comprising, if the connection to the receiving party according to at least one of the first and second call setting methods succeeds, storing a call setting method of the receiving party.

12. The method of claim 11, further comprising:
searching the call setting method of the receiving party to be connected from the plurality of call setting methods; and
if the call setting method of the receiving party is searched, selecting the searched call setting method.

13. The method of claim 9, further comprising, if the connection to the receiving party according to at least one of the first and second call setting methods fails, displaying a message indicating that the connection to the receiving party according to the at least one of the first and second call setting methods fails.

14. A method for processing calls of an Internet facsimile, the Internet facsimile supporting and processing a plurality of call request methods, the method comprising:
sensing a type of port from which a connection is requested; and
processing a call request according to a call request method corresponding to the port type.

15. The method of claim 14, further comprising storing the call request method.

16. The method of claim 14, further comprising displaying the processed result.

17. A computer-readable recording medium having embodied thereon a computer program for executing a method for processing calls of an Internet facsimile, the Internet facsimile supporting a plurality of call setting methods, the method comprising:
selecting a first call setting method from a plurality of call setting methods;
attempting a connection to a receiving party according to the first call setting method;
sensing a type of port from which a connection is requested;
if the connection to the receiving party according to the first call setting method fails, selecting a second call setting method different from the first setting method, and attempting a connection to the receiving party according to the second call setting method; and
processing a call request according to a call request method corresponding to the port type.

18. The method of claim 17, wherein the selecting of the first call setting method comprises sequentially selecting from the plurality of the call setting methods.

19. The method of claim 17, further comprising, if the connection to the receiving party according to at least one of the first and second call setting methods succeeds, storing a call setting method of the receiving party.

20. The method of claim 19, further comprising:
searching the call setting method of the receiving party to be connected from the plurality of call setting methods; and
if the call setting method of the receiving party is searched, selecting the searched call setting method.

21. The method of claim 17, further comprising, if the connection to the receiving party according to at least one of the first and second call setting methods fails, displaying a message indicating that the connection to the receiving party according to the at least one of the first and second call setting methods fails.

22. An apparatus for processing calls of an Internet facsimile, comprising:
a call setting unit for supporting a plurality of call setting methods and performing a call setting;
a controller for selecting at least one call setting method from the plurality of the call setting methods and controlling the call setting;
a connection unit for attempting a connection to a receiving party according to the selected call setting method.

23. The apparatus of claim 22, further comprising:
a port sensing unit for sensing a type of port from which a connection is requested;
a call request processing unit for supporting and processing a plurality of call request methods; and
a call request processing controller for controlling the call request processing unit to process a call request according to a call request method corresponding to the port type.

24. The apparatus of claim 22, wherein the controller selects a different call setting method, if the connection to the receiving party fails.

25. The apparatus of claim 22, further comprising:
a call setting method storing unit for storing a call setting method of the receiving party; and
a call setting method writing unit for writing a call setting method of the receiving party to the call setting method storing unit, if the connection to the receiving party according to the selected call setting method succeeds.

26. The apparatus of claim 23, further comprising:
a call request method storing unit for storing a call request method of a transmitting party; and
a call request method writing unit for writing a call request method of a transmitting party to the call request method storing unit.

27. The apparatus of claim 22, further comprising:
a call setting method searching unit for searching for the call setting method of a receiving party to be connected in the call setting method storing unit,
wherein the controller selects the searched call setting method.

28. The apparatus of claim 22, further comprising an error display unit for displaying a message indicating that the connection to the receiving party according to the selected call setting method fails, if the connection to the receiving party according to the selected call setting method fails.

29. The apparatus of claim 23, further comprising a processing result display unit for displaying the processed result.
